(19) United States
(12) Patent Application Publication
(10) Pub. No.: US 2025/0188557 A1
(43) Pub. Date: Jun. 12, 2025

(54) NON-ORIENTED SILICON STEEL FOR HIGH-SPEED MOTOR, AND MANUFACTURING METHOD THEREFOR

(71) Applicants: ZHANGJIAGANG YANGTZE RIVER COLD ROLLED PLATE CO., LTD., Suzhou, Jiangsu (CN); INSTITUTE OF RESEARCH OF IRON AND STEEL, JIANGSU PROVINCE/SHA-STEEL, CO. LTD (CN), Suzhou, Jiangsu (CN); JIANGSU SHAGANG GROUP CO., LTD., Suzhou, Jiangsu (CN)

(72) Inventors: Chongxiang YUE, Suzhou (CN); Haotian LAN, Suzhou (CN); Xianjun HU, Suzhou (CN); Henan ZHU, Suzhou (CN)

(73) Assignees: ZHANGJIAGANG YANGTZE RIVER COLD ROLLED PLATE CO., LTD., Suzhou, Jiangsu (CN); INSTITUTE OF RESEARCH OF IRON AND STEEL, JIANGSU PROVINCE/SHA-STEEL, CO. LTD (CN), Suzhou, Jiangsu (CN); JIANGSU SHAGANG GROUP CO., LTD., Suzhou, Jiangsu (CN)

(21) Appl. No.: 18/840,409

(22) PCT Filed: Sep. 16, 2022
(86) PCT No.: PCT/CN2022/119212

§ 371 Date: Aug. 21, 2024

(30) Foreign Application Priority Data
Sep. 13, 2022 (CN) 202211107301.5

(51) Int. Cl. C21D 9/00; C21D 6/00; C21D 8/12; C22C 38/00; C22C 38/02; C22C 38/04; C22C 38/06; C22C 38/42; C22C 38/44; C22C 38/46; C22C 38/48; C22C 38/50; C22C 38/60; H01F 1/147

(52) U.S. Cl. CPC C21D 9/0068; C21D 6/008; C21D 8/1205; C21D 8/1222; C21D 8/1233; C21D 8/1261; C21D 8/1283; C22C 38/001; C22C 38/002; C22C 38/008; C22C 38/02; C22C 38/04; C22C 38/06; C22C 38/42; C22C 38/44; C22C 38/46; C22C 38/48; C22C 38/50; C22C 38/60; H01F 1/14791; C22C 2202/02

(57) ABSTRACT

A non-oriented silicon steel for a high-speed motor and a manufacturing method therefor. The chemical components of the non-oriented silicon steel for a high-speed motor are as defined in the description, wherein the thickness of a finished product is 0.20-0.30 mm, and the grain size of the finished product is 80-100 μm. The manufacturing method for the non-oriented silicon steel for a high-speed motor comprises: performing smelting and casting into a continuous casting billet, and performing cooling, heating, hot rolling, normalizing, pickling, cold rolling, annealing and coating treatment on the continuous casting billet.

### CROSS-REFERENCE TO RELATED APPLICATIONS

The present application claims priority of the Chinese Patent Application No. 202211107301.5, filed on Sep. 13, 2022 before the China National Intellectual Property Administration, with the title of “NON-ORIENTED SILICON STEEL FOR HIGH-SPEED MOTOR, AND MANUFACTURING METHOD THEREFOR”, which is hereby incorporated by reference in its entirety.

### TECHNICAL FIELD OF THE INVENTION

The present application relates to the technical field of non-oriented silicon steel, and particularly relates to non-oriented silicon steel for a high-speed motor and a manufacturing method therefor.

### BACKGROUND OF THE INVENTION

High-speed motors usually refer to motors with a rotation speed exceeding 10,000 r/min. High-speed motors have significant advantages such as high rotation speed, relatively small size, high power density, high efficiency and the like. They are relatively widely used in centrifugal compressors of air conditioners and refrigerators, energy storage flywheels, high-speed grinders and many other applications, and they have broad application prospects in electric vehicles and distributed power generation systems. Currently, it has become one of the research hotspots in the international electrotechnical field.

The main characteristics of high-speed motors are high rotor speed, high stator winding current and high magnetic flux frequency in the iron core. The centrifugal force on the motor rotor is directly proportional to the square of the linear speed. Since the rotation speed of high-speed motors exceeds 10,000 r/min, the non-oriented silicon steel for rotor iron core is required to have very high mechanical strength. At the same time, in order to meet the technical indicators of high rotation speeds of high-speed motors, the volume of high-speed motors is much smaller than that of normal-speed motors of the same power. Therefore, the non-oriented silicon steel for iron core is required to have relatively high magnetic induction. In short, in order to achieve the high rotation speed, small volume and high efficiency control requirements of high-speed motors, the non-oriented silicon steel as the core material of its iron core should have higher strength, lower high-frequency iron loss P_{1.0/1000} and higher magnetic induction.

Most of the existing non-oriented silicon steel production technologies only focus on iron losses at frequencies of 50 Hz to 400 Hz. Only a small number of production technologies focus on iron losses at frequencies of 1000 Hz and above. However, the production process is complex and difficult to meet the needs of the rapid development of high-speed motors in the future.

For example, patent document with Chinese patent publication No. CN111471927A discloses high magnetic induction non-oriented silicon steel for automobile generators and a preparation method thereof. The non-oriented silicon steel comprises the following chemical components in weight percentage: 0.60%-1.60% of Si, 0.10%-0.65% of Mn, 0.040%-0.100% of P, 0-0.0080% of Al, 0.01%-0.10% of Sn, 0-100 ppm of (C+S+O+N+Ti) (in which the content of each element is less than or equal to 25 ppm), and the balance of Fe and unavoidable impurity elements. Through composition and process design optimization, the final product's magnetic properties meet that the iron loss P_{1.5/50} is less than or equal to 4.50 W/kg, and magnetic induction B₅₀₀₀ is greater than or equal to 1.74 T; and the mechanical properties meet that the Vickers microhardness HV1 is in a range from 110 to 120, and the elongation A50 is greater than or equal to 40%.

Patent document with Chinese patent publication No. CN107964631B discloses non-oriented silicon steel for high-speed motor rotor with a yield strength greater than or equal to 500 MPa, which comprises the chemical components in weight percentage: 4.12%-4.5% of Si, 1.62%-2.0% of Al, 0.5%-2.0% of Mn, 0-0.005% of N, 0-0.002% of S, 0-0.003% of C, 0-0.05% of P, 0-0.05% of Cu, and 0-0.01% of (Ti+Nb+V+Zr). Production method comprises converter smelting, RH vacuum refining, heating of the casting billet, rough rolling and then finishing rolling, coiling, pickling, cold rolling, and annealing. The yield strength of the non-oriented silicon steel for high-speed motor rotors disclosed in this application is higher than or equal to 500 MPa, and the iron loss P_{1.0/400} of the finished product with a thickness of 0.35 mm and below is less than or equal to 18 W/kg.

Patent document with Chinese patent publication No. CN107974620 B discloses a non-oriented silicon steel for high-speed rotors with a yield strength of 600 Mpa, which comprises the following chemical components in weight percentage: 0.001%-0.003% of C, 2.6%-3.4% of Si, 0.20%-0.60% of Mn, 0-0.005% of P, 0-0.005% of S, 0.75%-0.95% of Al, 0.002%-0.006% of N, and 0.053%-0.20% of Nb. Production step comprises smelting by a converter and casting into a billet, heating the continuous casting billet, conventional rough rolling and finish rolling, normalizing, cold rolling after pickling, and continuous annealing. This application discloses that the finished product of non-oriented silicon steel with a thickness not exceeding 0.35 mm has a yield strength greater than or equal to 600 MPa, a tensile strength greater than or equal to 700 MPa, a P_{1.0/400} less than or equal to 35 W/kg, and a B₅₀₀₀ greater than or equal to 1.60 T.

Although the non-oriented silicon steel for ordinary motors provided by the above patents CN111471927A, CN107964631B and CN107974620B can meet the requirements of high-speed motors in terms of mechanical strength and magnetic induction, they only focus on the iron loss under the frequency condition of 50 Hz to 400 Hz. The iron loss of non-oriented silicon steel includes hysteresis loss, eddy current loss and abnormal loss. Since abnormal loss accounts for a small proportion of iron losses, hysteresis loss and eddy current loss are generally focused on. Hysteresis loss Pₕ=kₕ*f*B², and eddy current loss Pₑ=kₑ*f²*B². It can be seen from the formulas of hysteresis loss and eddy current loss that hysteresis loss Pₕ is directly proportional to f, and eddy current loss Pₑ is directly proportional to f². Therefore, as the frequency increases, the eddy current loss in the iron loss increases significantly. At low-frequency (50 Hz-400 Hz) condition, hysteresis loss accounts for the majority of the iron loss; at high-frequency (greater than or equal to 1,000 Hz) condition, eddy current loss accounts for the majority of the iron loss. Obviously, due to the composition difference in iron loss under high-frequency and low-frequency conditions, it is difficult for non-oriented silicon steel with good magnetic properties under low-frequency conditions to ensure that it still has good magnetic properties under high-frequency conditions. That is, the non-oriented silicon steel and the production method described in the above patents are difficult to meet the use requirements of high-frequency iron loss P_{1.0/1000} of non-oriented silicon steel for a high-speed motor, and have the disadvantage of high iron loss at high frequencies.

Patent document with Chinese patent publication No. CN104480386B discloses a 0.2 mm thick non-oriented silicon steel for a high-speed motor, which comprises the following components in weight percentage: 0.001%-0.025% of C, 2.6%-3.0% of Si, 0.25%-0.55% of Al, 0.10%-0.30% of Mn, 0-0.015% of P, 0.001%-0.0025% of S, and 0.001%-0.0025% of N. Production step comprises: smelting and casting into steel ingots using a vacuum induction furnace; billet heating; heating after forging; hot rolling; normalizing; pickling; first cold rolling; intermediate annealing; second cold rolling; finished product annealing; and conventional cooling, shearing, sample preparation, magnetic and mechanical property measurements. On the premise of ensuring the magnetic properties P_{1.0/1000} is less than or equal to 40 w/kg and B₅₀₀₀ is greater than or equal to 1.68 T, this application takes into account the mechanical performance with a yield ratio of 0.70 to 0.73, which meets the requirements for manufacturing high-speed motor iron cores.

Patent document with Chinese patent publication No. CN112538592 B discloses a non-oriented silicon steel for a high-speed motor with a frequency of more than or equal to 10,000 Hz, which comprises the following components in weight percentage: 0-0.003% of C, 2.8%-3.5% of Si, 0.05%-1.0% of Mn, 0-0.0015% of P, 0-0.0008% of N, 0.75%-1.5% of Al, 0-0.0009% of S, 0.001%-0.1% of Sb, and 0.001%-0.1% of Sn, and satisfies that the content of (Sb+Sn) is in a range from 0.001% to 0.1%. Production step comprises: smelting and casting into billets; heating the casting billet and holding of casting billets at certain temperature, hot rolling, and coiling; normalizing, holding at certain temperature, pickling and coiling; first cold rolling; first continuous annealing; second cold rolling; second continuous annealing; third cold rolling; continuous annealing of finished product; slow cooling, insulation layer coating and curling. This application achieves excellent magnetic properties at a thickness of 0.02 to 0.15 mm, that is, P_{0.1/1000} does not exceed 15.5 W/kg, P_{0.1/400} does not exceed 9.5 W/kg, and B₅₀₀₀ does not exceed 1.6 T.

Patent documents with Chinese patent publication Nos. CN104480386B and CN112538592B respectively disclose non-oriented silicon steel for a high-speed motor with current frequencies of 1000 Hz and 10,000 Hz. However, their production processes are complex and the costs are high. For example, patent document with Chinese patent publication No. CN104480386B discloses a 0.2 mm thick non-oriented silicon steel for a high-speed motor, and its production process adopts secondary cold rolling and secondary annealing; while patent document with Chinese patent publication No. CN112538592B discloses non-oriented silicon steel for a high-speed motor with a frequency of more than or equal to 10,000 Hz, and its production process includes three times of cold rolling and three times of annealing.

It can be seen that most of the existing non-oriented silicon steel production technologies only focus on iron losses at frequencies of 50 Hz to 400 Hz. Only a small amount of production technologies focus on iron losses at frequencies of 1000 Hz and above, however, their production processes are complex, and are difficult to meet the needs of the rapid development of high-speed motors in the future.

### SUMMARY OF THE INVENTION

The technical problem to be solved by the present application is to overcome the existing defects of complex production processes or relatively high iron loss at high frequencies in the existing technology of non-oriented silicon steel for a high-speed motor, thereby providing a non-oriented silicon steel for a high-speed motor and a preparation method thereof.

To this end, the present application provides a non-oriented silicon steel for a high-speed motor, which comprises the following chemical components in weight percentage: 0-0.0020% of C, 0-0.0010% of S, 0-0.0030% of N, 3.0%-3.4% of Si, 0.80%-1.0% of Al, 0.2%-0.4% of Mn, 0-0.01% of P, 0-0.004% of (Sn+Sb), 0-0.005% of Nb, 0-0.005% of V, 0-0.005% of Ti, 0-0.005% of Mo, 0-0.05% of Cr, 0-0.05% of Ni, 0-0.05% of Cu, the balance of Fe and inevitable inclusions; wherein, 0<(C+S+N)<0.0050%; the thickness of the finished product is in a range from 0.20 mm to 0.30 mm, and the grain size of the finished product is in a range from 80 m to 100 m.

Further, the yield strength of the non-oriented silicon steel for a high-speed motor is greater than or equal to 550 MPa, the magnetic induction B₅₀₀₀ is greater than or equal to 1.65, the high-frequency iron loss at a thickness of 0.30 mm P_{1.0/1000} is less than or equal to 45 W/kg, the high-frequency iron loss at a thickness of 0.25 mm P_{1.0/1000} is less than or equal to 40 W/kg, and the high-frequency iron loss at a thickness of 0.20 mm P_{1.0/1000} is less than or equal to 35 W/kg.

Further, 4.8%≤(Si+2Al)≤5.2%.

The main functions of each element and process in the present application are as follows.

For 0-0.0020% of C, 0-0.0010% of S, and 0-0.0030% of N: C, S and N are all harmful elements in non-oriented silicon steel, increased C content results in high iron loss and low magnetic induction, high C content can also cause magnetic aging problems, thus, the lower their content, the better. S and Mn form fine MnS, and N and Al form fine AlN, which not only hinders the growth of grains during annealing, but also directly hinders domain wall movement and increases hysteresis loss. Non-oriented silicon steel generally adopts vacuum refining, thus it is not difficult to control C below 0.002% and N below 0.003%. Generally, the S content of medium-grade and low-grade non-oriented silicon steel is controlled below 0.0030%. If the S content continues to be reduced, the cost will increase. However, for high-grade non-oriented silicon steel for a high-speed motor in the present application, since the Si content is controlled at 3.0%-3.4% and the Al content is controlled at 0.80%-1.0%, the O content in the molten steel is greatly reduced. According to the desulfurization reaction CaO+S=CaS+O, after the O content in the molten steel is reduced, the difficulty of desulfurization is reduced. Therefore, in the present application, C content is controlled below 0.0020%, S content is controlled below 0.0010%, N content is controlled below 0.0030%, and at the same time the condition 0<(C+S+N)<0.0050% is controlled. The control of harmful elements C, S, and N not only reduces the hysteresis loss of the non-oriented silicon steel of the present application during high-frequency operation, but also improves the magnetic induction and reduces magnetic aging.

For 3.0%-3.4% of Si and 0.80%-1.0% of Al: Both Si and Al are effective additive elements that increase electrical resistivity, reduce iron loss, and increase strength. However, with the increase of Si and Al content, the difficulty for rolling the steel increases, hot rolling process is prone to edge cracking, and cold rolling process is prone to strip breakage; especially when the Si content is greater than 3.5%, the difficulty for rolling increases dramatically. Meanwhile, the magnetic induction of the steel plate decreases with the increase of Si and Al content. In the present application, the Si content is controlled at 3.0%-3.4%, and the Al content is controlled at 0.80%-1.0%, which reduces high-frequency iron loss, increases the strength of the steel plate, significantly reduces the O content in the molten steel at the same time, and creating conditions for ultra-low S smelting. With the measures of controlling chemical composition of P and (Sn+Sb), naturally cooling the continuous casting billet to 400° C.-500° C., then heating to 1,080° C.-1,100° C. at a heating rate of no more than 10° C./min, and then holding at this temperature for 0.5 h-1.0 h before hot rolling, low temperature normalizing at 830° C.-870° C. and preheating the steel plate to 100° C.-200° C. before cold rolling, stable production without edge cracks in hot rolling and stable production at high reduction rates in cold rolling, and a low strip breakage rate in cold rolling of 0.5% can be achieved. Moreover, through the above-mentioned low-temperature normalizing process, the finished product has a relatively high magnetic induction.

For 0.2%-0.4% of Mn: Adequate addition of Mn is beneficial to improving the magnetic properties of the steel plate while improving the strength of the steel plate; Mn can inhibit the thermal brittleness caused by S and easily form coarse MnS precipitates with S, thereby reducing the iron loss of the steel plate. The price of Mn alloy is relatively high. Based on cost considerations, the Mn content in the present application is controlled to be 0.2% to 0.4%. Since the S content in the present application is less than or equal to 0.0010%, the Mn/S is relatively high, which promotes the precipitation and growth of MnS and is beneficial to the magnetic properties.

For 0-0.01% of P: P has little effect on magnetism. Increasing the P content can effectively improve the strength of the steel plate. However, for high-grade non-oriented silicon steel, after the P content increases, the production difficulty for cold rolling increases significantly, and the rolling process is prone to strip breakage. The concept of the present application is to adopt high Si, high Al composition design and finished product thin specification design, and obtain high strength through finished product fine grain control; the finished product thickness is obtained through one cold rolling, so P content should be controlled to be less than or equal to 0.01%, so as to improve the rollability of the steel plate, and simplify the production process.

For 0-0.004% of (Sn+Sb): Both Sn and Sb are grain boundary clustering elements. Adding Sn alone, adding Sb alone or adding Sn and Sb in combination in non-oriented silicon steel are all aimed to reduce the proportion of {111}unfavorable textures and improve the magnetic induction of the finished product through clustering of Sn and Sb at grain boundaries. The effect is more obvious especially in the production process without normalizing process. However, due to the grain boundary clustering behavior of Sn and Sb, it leads to embrittlement of grain boundary in the steel plate, and the cold rolling is prone to strip breakage, and the production difficulty increases. In the present application, before cold rolling, the hot-rolled coils undergo normalizing treatment, which can significantly reduce the proportion of {111}unfavorable textures in the finished product. Therefore, when the composition is designed, Sn and Sb are not intentionally added, and the content of (Sn+Sb) is controlled to be less than or equal to 0.004%, so as to ensure the rollability of the steel plate and simplify the production process.

For 0-0.005% of Nb, 0-0.005% of V, 0-0.005% of Ti, 0-0.005% of Mo, 0-0.05% of Cr, 0-0.05% of Ni, 0-0.05% of Cu: Nb, V, Ti, Mo, Cr, Ni, and Cu reduce the grain size of the finished non-oriented silicon steel, resulting in a decrease in the magnetic properties of the non-oriented silicon steel under low-frequency conditions, including an increase in iron loss and a decrease in magnetic induction intensity; the non-oriented silicon steel for a high-speed motor in the present application requires that the finished product has low iron loss under high-frequency operating conditions, and it is necessary to appropriately reduce the grain size to reduce eddy current losses. Therefore, the presence of appropriate contents of Nb, V, Ti, Mo, Cr, Ni, and Cu in the non-oriented silicon steel for a high-speed motor in the present application can reduce the grain size of the non-oriented silicon steel finished product, which is not only beneficial to improving strength, but also beneficial to reducing high-frequency eddy current losses. However, considering that the prices of the alloy of these elements are relatively high, in the present application, they are not intentionally added, but only appropriately relaxed their control requirements to reduce the difficulty of steelmaking. The following conditions are controlled: Nb≤0.005%, V≤0.005%, Ti≤0.005%, Mo≤0.005%, Cr≤0.05%, Ni≤0.05%, and Cu≤0.05%.

The iron loss of non-oriented silicon steel includes hysteresis loss, eddy current loss and abnormal loss. Hysteresis loss is the energy loss caused by a hysteresis phenomenon in which inclusions, crystal defects, internal stress, crystal orientation and other factors in the material hinder the movement of domain walls during the magnetization and reversal magnetization processes of magnetic materials, and the change in magnetic flux is blocked, causing the magnetic induction intensity to lag behind the change in magnetic field intensity. Eddy current loss is the energy loss caused by eddy current caused by the local electromotive force induced around the magnetic flux according to Faraday's electromagnetic induction law when the magnetic flux changes size or direction during the alternating magnetization process of magnetic materials. That is to say, when the magnetic wall moves, the magnetization changes rapidly and produces eddy current loss, which can be calculated according to the classic eddy current loss formula. Abnormal loss is the energy loss caused by the different magnetic domain structures when the material is magnetized, and it accounts for a small proportion of the iron loss.

It can be seen that whether it is hysteresis loss, eddy current loss, or abnormal loss, it is the energy loss generated by magnetic materials during the magnetization and reversal magnetization processes. Since abnormal loss accounts for a small proportion in iron losses, hysteresis losses and eddy current losses are generally focused on. Hysteresis loss Pₕ=kₕ*f*B², eddy current loss Pₑ=kₑ*f²*B². At power frequency (50 Hz), hysteresis loss accounts for about 70% and eddy current loss accounts for about 30%. It can be seen from the formulas of hysteresis loss and eddy current loss that Pₕ is directly proportional to f, and Pₑ is directly proportional to f². Therefore, as the frequency increases, the eddy current loss in the iron loss increases significantly. At low-frequency (50 Hz-400 Hz) conditions, hysteresis loss accounts for the majority of the iron loss; at high-frequency (greater than or equal to 1000 Hz) conditions, eddy current loss accounts for the majority of the iron loss.

Due to the different compositions of low-frequency and high-frequency iron losses, the present application adopts a completely different design concept from traditional non-oriented silicon steel.

For the design concept of traditional non-oriented silicon steel, under low-frequency conditions, for non-oriented silicon steel with the same composition, due to the high proportion of hysteresis loss, the process design is generally required to be designed around the large grain of the finished product. Because the grain boundaries will hinder the movement of domain walls, the grains will increase in size, the grain boundaries will decrease, the hysteresis loss will be less, and the iron loss will be low. The large grain design of the finished product is beneficial to reducing low-frequency iron loss, but the strength of the steel plate decreases as the grain increases in size. That is, under low-frequency conditions, low iron loss and high strength are contradictory for grain size control. In order to reduce iron loss, the grain size should be increased, and then the strength should be increased through other strengthening methods such as solid solution strengthening, precipitation strengthening, dislocation strengthening and the like. For example, adding Cu, Cr, Ni, Nb, V, Ti and other alloying elements in the composition design; performing incomplete recrystallization annealing or secondary cold rolling in the process design; or a combination of the above two methods.

For the design concept of the non-oriented silicon steel in the present application, under high-frequency conditions, for non-oriented silicon steel with the same composition, due to the relatively high proportion of eddy current loss, the finished product grains no longer pursue large grains during process design, because after the grains become larger, the grain boundaries are reduced, the magnetic domain movement speed increases, causing the magnetization to change rapidly, thus increasing the eddy current loss. In other words, under high-frequency conditions, the eddy current loss, which accounts for the largest proportion of high-frequency iron loss, can be reduced by reducing the grain size. Although hysteresis loss will increase, the overall high-frequency iron loss will decrease. At the same time, the strength of the steel plate can be improved with the help of grain refinement. That is, under high-frequency conditions, for grain size control, low iron loss and high strength are organically unified. By controlling the grain size, fine grain strengthening and high-frequency low iron loss can be achieved at the same time.

The present application also provides a method for preparing the non-oriented silicon steel for a high-speed motor, which comprises performing smelting and casting into a continuous casting billet, performing cooling and heating on the continuous casting billet, hot rolling, normalizing to form recrystallized grains and obtain normalized steel plates, pickling to obtain pickled steel plates, cold rolling, annealing, and coating treatment.

Further, the normalizing is performed at a temperature ranging from 830° C. to 870° C. for a time period ranging from 3 min to 5 min; a reduction rate of the cold rolling is controlled in a range from 89% to 90%; and the annealing is performed at a temperature ranging from 880° C. to 900° C. for a time period ranging from 120s to 150s.

Further, a vacuum induction furnace is used for smelting, the content of (C+S+N) is controlled to be greater than 0 and less than or equal to 0.0050%, and a continuous casting billet with a thickness of 200 mm to 250 mm is casted.

Further, the step of cooling and heating on the continuous casting billet comprises naturally cooling the continuous casting billet to a temperature ranging from 400° C. to 500° C., then heating to a temperature ranging from 1,080° C. to 1,100° C. at a heating rate of no more than 10° C./min, and then keeping at this temperature for 0.5 h to 1.0 h.

Further, the hot rolling includes 6 passes of rough rolling and 7 passes of finish rolling processes; and/or, an intermediate billet with a thickness of 30 mm to 45 mm is obtained through rough rolling, and a hot-rolled plate with a thickness of 2.0 mm to 3.0 mm is obtained through finish rolling; and/or, a final rolling temperature of finishing rolling is in a range from 800° C. to 860° C., a cooling temperature of finishing rolling is in a range from 600° C. to 660° C., the variation range of the final rolling temperature of finishing rolling and the cooling temperature of finishing rolling is ±15° C., and the total reduction rate of finishing rolling is in a range from 92.5% to 93.5%.

Further, after normalizing, the steel plates are cooled to a temperature ranging from 80° C. to 150° C., and then shot blasting and pickling processes are performed.

Existing conventional reagents can be used for pickling, such as using hydrochloric acid for pickling. The temperature of the acid solution is in a range from 75° C. to 85° C., and the concentration of hydrochloric acid in the acid solution is in a range from 120 g/L to 160 g/L.

Further, the steel plate is preheated to a temperature ranging from 100° C. to 200° C. before cold rolling; and/or, a size of the recrystallized grains after normalizing is in a range from 60 m to 80 m, and a volume ratio of the recrystallized grains is 100%.

The technical solution of the present application has the following advantages.

1. The non-oriented silicon steel for a high-speed motor provided in the present application comprises the following chemical components in weight percentage: C≤0.0020%, S≤0.0010%, N≤0.0030%, Si: 3.0%-3.4%, Al: 0.80%-1.0%, Mn: 0.2%-0.4%, P≤0.01%, Sn+Sb≤0.004%, Nb≤0.005%, V≤0.005%, Ti≤0.005%, Mo≤0.005%, Cr≤0.05%, Ni≤0.05%, Cu≤0.05%, the balance of Fe and inevitable inclusions; wherein, 0<C+S+N≤0.0050%; the thickness of the finished product is in a range from 0.20 mm to 0.30 mm, and the grain size of the finished product is in a range from 80 m to 100 m. Through precise control of chemical composition and the control of the thickness and grain size of the finished product, it not only improves the strength, but also reduces the high-frequency iron loss P_{1.0/1000}, and has low smelting cost, simple production process and low production cost. It meets the application requirements of high rotation speed, small volume and high efficiency for high-speed motors. There is no need to add additional alloy strengthening elements such as Cu, Cr, Ni, Nb, V, Ti, etc., and there is no need to add texture control elements such as Sn, Sb, etc.

2. The non-oriented silicon steel for a high-speed motor provided in the present application has a finished product yield strength of greater than or equal to 550 MPa, a magnetic induction B₅₀₀₀ greater than or equal to 1.65, a high-frequency iron loss at a thickness of 0.30 mm P_{1.0/1000} less than or equal to 45 W/kg, a high-frequency iron loss at a thickness of 0.25 mm P_{1.0/1000} less than or equal to 40 W/kg, and a high-frequency iron loss at a thickness of 0.20 mm P_{1.0/1000} less than or equal to 35 W/kg, which meets the needs of the rapid development of high-speed motors in the future.

3. The method for preparing non-oriented silicon steel for a high-speed motor provided in the present application includes smelting and casting into continuous casting billets, cooling and heating on the continuous casting billets, hot rolling, normalizing, pickling, cold rolling, annealing and coating treatment, which has a short production process and high production efficiency. Through the control of chemical composition and the above-mentioned whole process flow design, by means of resistivity control, inclusion control, texture control, grain size control and the like, the contradiction among high-frequency iron loss, magnetic induction and strength is reconciled and high strength, high magnetic properties and excellent high-frequency magnetic properties are achieved at the same time.

4. The method for preparing non-oriented silicon steel for a high-speed motor provided in the present application avoids cracks in high-silicon steel continuous casting billet and ensures smooth hot rolling by controlling the content of P, Sn, and Sb elements in the composition design, combined with controlling the temperature of the natural cooling of the continuous casting billet and heating rate; by controlling the recrystallized grain size after normalizing and preheating before cold rolling, high silicon steel can be cold-rolled at a large reduction rate in one time, and a finished product with a thickness of 0.20 mm to 0.30 mm can be obtained by one annealing, which has a short production process and high production efficiency.

5. In the method for preparing non-oriented silicon steel for a high-speed motor provided in the present application, normalizing at a temperature ranging from 830° C. to 870° C. for 3 min to 5 min and heating at low temperature for a longer period of time can not only achieve complete recrystallization of hot rolled sheet, but also avoid grain size being too large, so that the grain size is in a range from 60 μm to 80 μm. The reason why the reduction rate of cold rolling is controlled to be in a range from 89% to 90% is to increase the storage energy and nucleation point, increase the annealing nucleation rate, and create conditions for precise and stable control of the grain size of the finished product during the annealing process. Combined with annealing at a temperature ranging from 880° C. to 900° C. for 120s to 150s, the control of the above three process conditions combined with precise control of chemical composition ensures complete recrystallization and controls the grain size of the finished product to be in a range from 80 μm to 100 μm.

### DETAILED DESCRIPTION OF THE INVENTION

The following examples are provided for a better and further understanding of the present application, which are not limited to the best embodiments described, and do not constitute a limitation on the contents and scope of protection of the present application, and any product identical or similar to the present application derived by any person under the inspiration of the present application or by combining the features of the present application with those of other prior art, falls within the scope of protection of the present application.

If no specific experimental steps or conditions are specified in the examples, the procedures can be carried out according to the conventional experimental steps or conditions described in literature in the art. If the manufacturer of the reagents or instruments used is not indicated, they are all conventional reagents and products that can be purchased commercially.

Examples 1 to 8 respectively provide a kind of non-oriented silicon steel for a high-speed motor, with a chemical composition in mass percentage as shown in Table 1, and the balance of Fe and inevitable inclusions; and the non-oriented silicon steel for a high-speed motor prepared in each example is specified as a steel plate with the thickness shown in Table 1.

TABLE 1

| | Chemical composition in mass percentage (%) | | | | | | | | | | | | | | | | Thickness |
|---|---|---|---|---|---|---|---|---|---|---|---|---|---|---|---|---|---|
| | C | S | N | Si | Al | Mn | P | Sn | Sb | Nb | V | Ti | Mo | Cr | Ni | Cu | (mm) |
| Example | 0.0016 | 0.0006 | 0.0018 | 3.10 | 0.88 | 0.35 | 0.006 | 0.001 | 0 | 0.004 | 0.002 | 0.003 | 0.003 | 0.04 | 0.01 | 0.02 | 0.30 |
| 1 | | | | | | | | | | | | | | | | | |
| Example | 0.0016 | 0.0006 | 0.0018 | 3.10 | 0.88 | 0.35 | 0.006 | 0.001 | 0 | 0.004 | 0.002 | 0.003 | 0.003 | 0.04 | 0.01 | 0.02 | 0.25 |
| 2 | | | | | | | | | | | | | | | | | |
| Example | 0.0016 | 0.0006 | 0.0018 | 3.10 | 0.88 | 0.35 | 0.006 | 0.001 | 0 | 0.004 | 0.002 | 0.003 | 0.003 | 0.04 | 0.01 | 0.02 | 0.20 |
| 3 | | | | | | | | | | | | | | | | | |
| Example | 0.0013 | 0.0008 | 0.0021 | 3.31 | 0.92 | 0.25 | 0.007 | 0.001 | 0 | 0.002 | 0.002 | 0.004 | 0.003 | 0.02 | 0.02 | 0.03 | 0.30 |
| 4 | | | | | | | | | | | | | | | | | |
| Example | 0.0013 | 0.0008 | 0.0021 | 3.31 | 0.92 | 0.25 | 0.007 | 0.001 | 0 | 0.002 | 0.002 | 0.004 | 0.003 | 0.02 | 0.02 | 0.03 | 0.25 |
| 5 | | | | | | | | | | | | | | | | | |
| Example | 0.0013 | 0.0008 | 0.0021 | 3.31 | 0.92 | 0.25 | 0.007 | 0.001 | 0 | 0.002 | 0.002 | 0.004 | 0.003 | 0.02 | 0.02 | 0.03 | 0.20 |
| 6 | | | | | | | | | | | | | | | | | |
| Example | 0.0015 | 0.0007 | 0.0015 | 3.05 | 0.84 | 0.38 | 0.005 | 0.001 | 0.001 | 0.003 | 0.004 | 0.003 | 0.003 | 0.03 | 0.01 | 0.03 | 0.25 |
| 7 | | | | | | | | | | | | | | | | | |
| Example | 0.0010 | 0.0006 | 0.0023 | 3.35 | 0.96 | 0.22 | 0.004 | 0.001 | 0.001 | 0.002 | 0.002 | 0.004 | 0.004 | 0.04 | 0.02 | 0.04 | 0.25 |
| 8 | | | | | | | | | | | | | | | | | |

The non-oriented silicon steel for a high-speed motor in each example of the present application is produced according to the following steps:
(1) using a vacuum induction furnace for smelting, controlling 0<(C+S+N)≤0.0050%, and casting into a continuous casting billet with a thickness of 220 mm; wherein the chemical composition of the continuous casting billet is shown in Table 1; during smelting, Nb, V, Ti, Mo, Cr, Ni, Cu were not specifically added, but the control requirements thereof are appropriately relaxed to control Nb≤0.005%, V≤0.005%, Ti≤0.005%, Mo≤0.005%, Cr≤0.05%, Ni≤0.05%, Cu≤0.05%, to reduce the difficulty of steelmaking;
(2) stacking the continuous casting billet obtained in step (1), and after naturally cooling to 450° C., sending it to the heating furnace, heating it at a heating rate of 5° C./min and then holding at this temperature; wherein the heating temperature and holding time are as shown in Table 2;
(3) carrying out rough rolling and finish rolling on the heated continuous casting billet of step (2); wherein the rough rolling is conducted using 1+5 mode, and the intermediate billet is obtained through six passes of rolling; then seven passes of finish rolling and coiling are carried out to obtain the hot rolled plate coil; the thickness of the intermediate billet obtained by rough rolling, the final rolling temperature of finishing rolling, the total reduction rate of the finishing rolling process, the thickness of the obtained hot rolled plate and the cooling temperature of finishing rolling are shown in Table 2;
(4) normalizing the hot-rolled coil plate obtained in step (3) under a pure dry N₂ atmosphere, wherein the normalizing temperature and normalizing time are as shown in Table 3; after normalizing, cooling the steel plate to 100° C., shot blasting and then pickling with hydrochloric acid, wherein the temperature of the acid solution is 80° C., the concentration of hydrochloric acid in the acid solution is 140 g/L, and the mass concentration of Fe²⁺ in the pickling solution is controlled at 50±20 g/L; carrying out metallurgical organization testing to the normalized steel plates in various examples, wherein the measured volume ratio of the recrystallized grains and the size of the recrystallized grains are shown in Table 3;
(5) preheating the normalized pickled steel plate obtained in step (4) and then performing cold rolling; wherein the preheating temperature, thickness before rolling, thickness after rolling, and the reduction rate of the cold rolling are as shown in Table 4;
(6) continuously annealing the rolled hard steel plate obtained in step (5) in a mixed atmosphere of H₂ and N₂ with a H₂ content of 15%, wherein the annealing temperature and holding time are as shown in Table 4; and
(7) coating and finishing the steel plates obtained in step (6) according to conventional methods.

TABLE 2

| | | | | | Total | | |
|---|---|---|---|---|---|---|---|
| | | | | | reduction | Thickness | Cooling |
| | | | | Final rolling | rate of | of hot | temperature |
| | Heating | Holding | Thickness of | temperature | finishing | rolled | of finishing |
| | temperature | time | intermediate | of finishing | rolling | plate | rolling |
| | (° C.) | (min) | billet (mm) | rolling (° C.) | (%) | (mm) | (° C.) |
| Example | 1092 | 45 | 40 | 838 | 92.50 | 3.0 | 635 |
| 1 | | | | | | | |
| Example | 1090 | 46 | 35 | 836 | 92.86 | 2.5 | 630 |
| 2 | | | | | | | |
| Example | 1091 | 44 | 30 | 828 | 93.33 | 2.0 | 638 |
| 3 | | | | | | | |
| Example | 1085 | 53 | 40 | 845 | 92.50 | 3.0 | 652 |
| 4 | | | | | | | |
| Example | 1088 | 56 | 35 | 849 | 92.86 | 2.5 | 648 |
| 5 | | | | | | | |
| Example | 1090 | 55 | 30 | 840 | 93.33 | 2.0 | 645 |
| 6 | | | | | | | |
| Example | 1095 | 38 | 35 | 818 | 92.86 | 2.5 | 610 |
| 7 | | | | | | | |
| Example | 1085 | 52 | 35 | 855 | 92.86 | 2.5 | 652 |
| 8 | | | | | | | |

TABLE 3

| | Normalizing | Normalizing | Volume ratio of | Size of |
|---|---|---|---|---|
| | temperature | time | recrystallized | recrystallized |
| | (° C.) | (s) | grains (%) | grains (μm) |
| Example 1 | 852 | 252 | 100 | 70 |
| Example 2 | 848 | 252 | 100 | 72 |
| Example 3 | 853 | 252 | 100 | 75 |
| Example 4 | 856 | 210 | 100 | 75 |
| Example 5 | 850 | 210 | 100 | 73 |
| Example 6 | 852 | 210 | 100 | 70 |
| Example 7 | 846 | 252 | 100 | 64 |
| Example 8 | 865 | 180 | 100 | 76 |

TABLE 4

| | | Thickness | | | | Holding |
|---|---|---|---|---|---|---|
| | Preheating | before | Thickness | Reduction | Annealing | time for |
| | temperature | rolling | after rolling | rate of cold | temperature | annealing |
| | (° C.) | (mm) | (mm) | rolling (%) | (° C.) | (s) |
| Example 1 | 120 | 3.0 | 0.30 | 90 | 890 | 135 |
| Example 2 | 120 | 2.5 | 0.25 | 90 | 892 | 135 |
| Example 3 | 120 | 2.0 | 0.20 | 90 | 895 | 135 |
| Example 4 | 140 | 3.0 | 0.30 | 90 | 888 | 135 |
| Example 5 | 140 | 2.5 | 0.25 | 90 | 892 | 135 |
| Example 6 | 140 | 2.0 | 0.20 | 90 | 895 | 135 |
| Example 7 | 160 | 2.5 | 0.25 | 90 | 886 | 125 |
| Example 8 | 180 | 2.5 | 0.25 | 90 | 896 | 145 |

### COMPARATIVE EXAMPLES

Comparative Examples 1 to 8 each provide a non-oriented silicon steel, which has a chemical composition in mass percentage as shown in Table 5; and the non-oriented silicon steel prepared in each comparative example is specifically a steel plate with a thickness shown in Table 5.

TABLE 5

| | Chemical composition in mass percentage (%) | | | | | | | | | | | | | | | | Thickness |
|---|---|---|---|---|---|---|---|---|---|---|---|---|---|---|---|---|---|
| | C | S | N | Si | Al | Ma | P | Su | Sb | Nb | V | Ti | Mo | Cr | Ni | Cu | (mm) |
| Comparative | 0.0013 | 0.0005 | 0.0016 | 3.15 | 0.86 | 0.33 | 0.009 | 0.001 | 0 | 0.002 | 0.003 | 0.002 | 0.002 | 0.01 | 0.01 | 0.02 | 0.30 |
| Example 1 | | | | | | | | | | | | | | | | | |
| Comparative | 0.0013 | 0.0005 | 0.0016 | 3.15 | 0.86 | 0.33 | 0.009 | 0.001 | 0 | 0.002 | 0.003 | 0.002 | 0.002 | 0.01 | 0.01 | 0.02 | 0.25 |
| Example 2 | | | | | | | | | | | | | | | | | |
| Comparative | 0.0013 | 0.0005 | 0.0016 | 3.15 | 0.86 | 0.33 | 0.009 | 0.001 | 0 | 0.002 | 0.003 | 0.002 | 0.002 | 0.01 | 0.01 | 0.02 | 0.20 |
| Example 3 | | | | | | | | | | | | | | | | | |
| Comparative | 0.0012 | 0.0007 | 0.0018 | 3.18 | 0.88 | 0.30 | 0.008 | 0.001 | 0 | 0.022 | 0.002 | 0.015 | 0.003 | 0.04 | 0.01 | 0.02 | 0.30 |
| Example 4 | | | | | | | | | | | | | | | | | |
| Comparative | 0.0012 | 0.0007 | 0.0018 | 3.18 | 0.88 | 0.30 | 0.008 | 0.001 | 0 | 0.022 | 0.002 | 0.015 | 0.003 | 0.04 | 0.01 | 0.02 | 0.25 |
| Example 5 | | | | | | | | | | | | | | | | | |
| Comparative | 0.0012 | 0.0007 | 0.0018 | 3.18 | 0.88 | 0.30 | 0.008 | 0.001 | 0 | 0.022 | 0.002 | 0.015 | 0.003 | 0.04 | 0.01 | 0.02 | 0.20 |
| Example 6 | | | | | | | | | | | | | | | | | |
| Comparative | 0.0015 | 0.0006 | 0.0020 | 3.55 | 0.85 | 0.34 | 0.006 | 0.03 | 0 | 0.002 | 0.002 | 0.001 | 0.001 | 0.02 | 0.02 | 0.02 | 0.30 |
| Example 7 | | | | | | | | | | | | | | | | | |
| Comparative | 0.0015 | 0.0006 | 0.0020 | 3.55 | 0.85 | 0.34 | 0.006 | 0.03 | 0 | 0.002 | 0.002 | 0.001 | 0.001 | 0.02 | 0.02 | 0.02 | 0.35 |
| Example 8 | | | | | | | | | | | | | | | | | |

The non-oriented silicon steels of Comparative Examples 1 to 8 are all organized and produced according to the design ideas of low-frequency non-oriented silicon steel.

In Comparative Examples 1 to 3, by controlling the normalizing temperature and holding time, the recrystallized grain size after normalizing is made larger, and combined with the control of the reduction rate of cold rolling, annealing temperature and holding time, large grains of the finished product are obtained. The specific process parameters are shown in Tables 6 to 8.

In Comparative Examples 4 to 6, based on Comparative Examples 1 to 3, the contents of Nb and Ti are increased in the composition design, and the strength of the steel plate is increased through the solid solution strengthening of micro-alloying elements Nb and Ti and fine grain strengthening effects.

In Comparative Example 7, the Si content is increased to beyond the scope of the present application during composition design, but the strip breakage is prone to occur during cold rolling. Therefore, in Comparative Example 8, the thickness of the finished product is increased to 0.35 mm based on Comparative Example 7 to reduce the risk of strip breakage.

The production steps of non-oriented silicon steel of Comparative Examples 1 to 8 are as follows:
(1) using a vacuum induction furnace for smelting, and casting into a continuous casting billet with a thickness of 220 mm, wherein the chemical composition of the continuous casting billet is shown in Table 5;
(2) stacking the continuous casting billet obtained in step (1), and after naturally cooling to 450° C., sending it to the heating furnace, heating it at a heating rate of 5° C./min and then holding at this temperature; wherein the heating temperature and holding time are as shown in Table 6;
(3) carrying out rough rolling and finish rolling on the heated continuous casting billet of step (2), wherein the rough rolling is conducted using 1+5 mode, and the intermediate billet is obtained through six passes of rolling; then carrying out seven passes of finish rolling and coiling to obtain the hot rolled plate coil, the thickness of the intermediate billet obtained by rough rolling, the final rolling temperature of finishing rolling, the total reduction rate of the finishing rolling process, the thickness of the obtained hot rolled plate and the cooling temperature of finishing rolling are shown in Table 6;
(4) normalizing the hot-rolled coil plate obtained in step (3) under a pure dry N₂ atmosphere, wherein the normalizing temperature and normalizing time are as shown in Table 7; after normalizing, cooling the steel plate to 100° C., shot blasting and then pickling with hydrochloric acid, wherein the temperature of the acid solution is 80° C., the concentration of hydrochloric acid in the acid solution is 140 g/L, and the mass concentration of Fe²⁺ is controlled at 50±20 g/L; carrying out metallurgical organization testing to the normalized steel plates in various comparative examples, wherein the measured volume ratio of the recrystallized grains and the size of the recrystallized grains are shown in Table 7;
(5) preheating the normalized pickled steel plate obtained in step (4) and then performing cold rolling, wherein the preheating temperature, thickness before rolling, thickness after rolling, and the reduction rate of the cold rolling are as shown in Table 8. In Comparative Example 7, strip breakage was occurred during the cold rolling process and the rolling was not completed;
(6) continuously annealing the rolled hard steel plate obtained in step (5) in a mixed atmosphere of H₂ and N₂ with a H₂ content greater than or equal to 15%, wherein the annealing temperature and holding time are as shown in Table 8; and
(7) coating and finishing the steel plates obtained in step (6) according to conventional methods.

TABLE 6

| | | | | | Total | | |
|---|---|---|---|---|---|---|---|
| | | | | | reduction | | |
| | | | | Final rolling | rate of | Thickness | Cooling |
| | | | Thickness of | temperature | the | of hot | temperature |
| | Heating | Holding | intermediate | of finishing | finishing | rolled | of finishing |
| | temperature | time | billet | rolling | rolling | plate | rolling |
| | (° C.) | (min) | (mm) | (° C.) | (%) | (mm) | (° C.) |
| Comparative | 1091 | 45 | 30 | 838 | 92.66 | 2.2 | 635 |
| Example 1 | | | | | | | |
| Comparative | 1093 | 44 | 30 | 841 | 93.33 | 2.0 | 640 |
| Example 2 | | | | | | | |
| Comparative | 1095 | 51 | 30 | 835 | 94.00 | 1.8 | 637 |
| Example 3 | | | | | | | |
| Comparative | 1091 | 53 | 30 | 836 | 92.66 | 2.2 | 642 |
| Example 4 | | | | | | | |
| Comparative | 1098 | 52 | 30 | 839 | 93.33 | 2.0 | 648 |
| Example 5 | | | | | | | |
| Comparative | 1094 | 45 | 30 | 840 | 94.00 | 1.8 | 645 |
| Example 6 | | | | | | | |
| Comparative | 1101 | 50 | 30 | 844 | 92.66 | 2.2 | 641 |
| Example 7 | | | | | | | |
| Comparative | 1095 | 52 | 30 | 845 | 92.33 | 2.3 | 642 |
| Example 8 | | | | | | | |

TABLE 7

| | | | Volume | |
|---|---|---|---|---|
| | Normalizing | Normalizing | ratio of | Size of |
| | temperature | time | recrystallized | recrystallized |
| | (° C.) | (s) | grains (%) | grains (μm) |
| Comparative | 893 | 215 | 100 | 103 |
| Example 1 | | | | |
| Comparative | 888 | 215 | 100 | 102 |
| Example 2 | | | | |
| Comparative | 885 | 215 | 100 | 106 |
| Example 3 | | | | |
| Comparative | 884 | 215 | 100 | 106 |
| Example 4 | | | | |
| Comparative | 890 | 215 | 100 | 103 |
| Example 5 | | | | |
| Comparative | 893 | 215 | 100 | 105 |
| Example 6 | | | | |
| Comparative | 889 | 215 | 100 | 104 |
| Example 7 | | | | |
| Comparative | 895 | 215 | 100 | 106 |
| Example 8 | | | | |

TABLE 8

| | | | | Reduction | | |
|---|---|---|---|---|---|---|
| | | Thickness | Thickness | rate of | | Holding |
| | Preheating | before | after | cold | Annealing | time for |
| | temperature | rolling | rolling | rolling | temperature | annealing |
| | (° C.) | (mm) | (mm) | (%) | (° C.) | (s) |
| Comparative | 120 | 2.2 | 0.30 | 86.4 | 992 | 180 |
| Example 1 | | | | | | |
| Comparative | 120 | 2.0 | 0.25 | 87.5 | 992 | 180 |
| Example 2 | | | | | | |
| Comparative | 120 | 1.8 | 0.20 | 88.8 | 991 | 180 |
| Example 3 | | | | | | |
| Comparative | 150 | 2.2 | 0.30 | 86.4 | 987 | 180 |
| Example 4 | | | | | | |
| Comparative | 150 | 2.0 | 0.25 | 87.5 | 993 | 180 |
| Example 5 | | | | | | |
| Comparative | 150 | 1.8 | 0.20 | 88.8 | 995 | 180 |
| Example 6 | | | | | | |
| Comparative | 180 | 2.2 | 0.30 | 86.4 | — | — |
| Example 7 | | | | | | |
| Comparative | 180 | 2.2 | 0.35 | 84.1 | 996 | 180 |
| Example 8 | | | | | | |

The size of recrystallized grains, volume ratio of recrystallized grains (%), yield strength, tensile strength and iron loss P_{1.0/1000} of the non-oriented silicon steel prepared in Examples 1 to 8, Comparative Examples 1 to 6 and Comparative Example 8 were tested, and the magnetic induction intensity B₅₀₀₀ of the non-oriented silicon steel prepared in Examples 1 to 8 and Comparative Examples 4 to 6 was tested. The results are shown in the table below.

TABLE 9

| | | | | | Iron | |
|---|---|---|---|---|---|---|
| | Volume ratio of | Size of | Yield | Tensile | loss | Magnetic |
| | recrystallized | recrystallized | strength | strength | P_{1.0/1000} | induction |
| | grains (%) | grains (μm) | (MPa) | (MPa) | (W/kg) | B₅₀₀₀ (T) |
| Example 1 | 100 | 85 | 585 | 643 | 42.1 | 1.671 |
| Example 2 | 100 | 91 | 574 | 635 | 38.8 | 1.667 |
| Example 3 | 100 | 88 | 586 | 645 | 31.7 | 1.663 |
| Example 4 | 100 | 92 | 569 | 638 | 40.9 | 1.673 |
| Example 5 | 100 | 95 | 576 | 646 | 36.6 | 1.658 |
| Example 6 | 100 | 88 | 572 | 642 | 30.6 | 1.663 |
| Example 7 | 100 | 84 | 565 | 628 | 39.4 | 1.662 |
| Example 8 | 100 | 95 | 588 | 656 | 36.2 | 1.658 |
| Comparative | 100 | 152 | 523 | 577 | 50.8 | — |
| Example 1 | | | | | | |
| Comparative | 100 | 148 | 530 | 581 | 43.2 | — |
| Example 2 | | | | | | |
| Comparative | 100 | 145 | 533 | 585 | 38.4 | — |
| Example 3 | | | | | | |
| Comparative | 100 | 125 | 559 | 621 | 59.3 | 1.655 |
| Example 4 | | | | | | |
| Comparative | 100 | 122 | 563 | 626 | 50.4 | 1.648 |
| Example 5 | | | | | | |
| Comparative | 100 | 120 | 568 | 634 | 45.2 | 1.642 |
| Example 6 | | | | | | |
| Comparative | — | — | — | — | — | — |
| Example 7 | | | | | | |
| Comparative | 100 | 147 | 554 | 625 | 58.2 | — |
| Example 8 | | | | | | |

It can be seen from the Examples 1 to 8 that the non-oriented silicon steel for a high-speed motor using the embodiments of the present application not only has high strength and relatively high magnetic induction, but also has low high-frequency iron loss P_{1.0/1000}, low smelting cost, simple production process, and low production cost, thus meeting the application requirements of high-speed motors.

The chemical compositions similar to those of Examples 1 to 3 were used in Comparative Examples 1 to 3, and finished products with large grains were obtained by controlling normalizing temperature, holding time, reduction rate of cold rolling, annealing temperature and holding time. However, the strength of the finished product is significantly lower than that of Examples 1 to 3, and the high-frequency iron loss P_{1.0/1000} at same finished product thickness is significantly higher than that of Examples 1 to 3.

Comparative Examples 4 to 6 are based on Comparative Examples 1 to 3, the contents of Nb and Ti are increased in the composition design, and the strength of the steel plate is slightly increased compared with Comparative Examples 1 to 3 through the solid solution strengthening of micro-alloying elements Nb and Ti and fine grain strengthening effects. The test results show that the grain size thereof is smaller than that of Comparative Examples 1-3 and the strength thereof is higher than that of Comparative Examples 1-3. Compared with Examples 1 to 3, the finished products with same thickness of Comparative Examples 4 to 6 have low the strength, high iron loss, low magnetic induction, and high alloy cost.

Instead of increasing the Nb and Ti contents, the Si content was increased to more than 3.5% in the composition design of Comparative Example 7. As a result, when rolling a steel plate with a target thickness of 0.30 mm, even though the preheating temperature before rolling has been raised to 180° C., strip breakage still occurred during cold rolling.

In Comparative Example 8, the thickness of the finished product is increased to 0.35 mm based on Comparative Example 7. As the thickness of the steel plate increases, its resistivity decreases, causing the high-frequency iron loss of the finished product to be significantly higher than that of Examples 1 to 8.

Obviously, the above-mentioned examples are only examples for clear explanation and are not intended to limit the embodiments. For those of ordinary skill in the art, other different forms of changes or modifications can be made based on the above description. An exhaustive list of all embodiments is neither necessary nor possible. The obvious changes or modifications derived therefrom are still within the protection scope of the present invention.

1. A non-oriented silicon steel for a high-speed motor, comprising the following chemical components in mass percentage: 0-0.0020% of C, 0-0.0010% of S, 0-0.0030% of N, 3.0%-3.4% of Si, 0.80%-1.0% of Al, 0.2%-0.4% of Mn, 0-0.01% of P, 0-0.004% of (Sn+Sb), 0-0.005% of Nb, 0-0.005% of V, 0-0.005% of Ti, 0-0.005% of Mo, 0-0.05% of Cr, 0-0.05% of Ni, 0-0.05% of Cu, the balance of Fe and inevitable inclusions; wherein, 0<(C+S+N)≤0.0050%; the thickness of finished product is in a range from 0.20 mm to 0.30 mm, and the grain size of finished product is in a range from 80 m to 100 m.

2. The non-oriented silicon steel for a high-speed motor according to claim 1, wherein the non-oriented silicon steel for a high-speed motor has a yield strength greater than or equal to 550 MPa, a magnetic induction B₅₀₀₀ greater than or equal to 1.65, a high-frequency iron loss at a thickness of 0.30 mm P_{1.0/1000} less than or equal to 45 W/kg, a high-frequency iron loss at a thickness of 0.25 mm P_{1.0/1000} less than or equal to 40 W/kg, and a high-frequency iron loss at a thickness of 0.20 mm P_{1.0/1000} less than or equal to 35 W/kg.

3. The non-oriented silicon steel for a high-speed motor according to claim 1, wherein, the content of (Si+2Al) is greater than or equal to 4.8 wt % and less than or equal to 5.2 wt %.

4. A method for preparing the non-oriented silicon steel for a high-speed motor according to claim 1, comprising performing smelting and casting into a continuous casting billet, performing cooling and heating on the continuous casting billet, hot rolling, normalizing to form recrystallized grains and obtain normalized steel plates, pickling to obtain pickled steel plates, cold rolling, annealing, and coating treatment.

5. The method for preparing the non-oriented silicon steel for a high-speed motor according to claim 4, wherein the normalizing is performed at a temperature ranging from 830° C. to 870° C. for a time period ranging from 3 min to 5 min; a reduction rate of the cold rolling is controlled to be in a range from 89% to 90%; and the annealing is performed at a temperature ranging from 880° C. to 900° C. for a time period ranging from 120s to 150s.

6. The method for preparing the non-oriented silicon steel for a high-speed motor according to claim 4, wherein a vacuum induction furnace is used for smelting, the content of (C+S+N) is controlled to be greater than 0 and less than or equal to 0.0050 wt %, and a continuous casting billet with a thickness of 200 mm to 250 mm is casted.

7. The method for preparing the non-oriented silicon steel for a high-speed motor according to claim 4, wherein the step of cooling and heating on the continuous casting billet comprises naturally cooling the continuous casting billet to a temperature ranging from 400° C. to 500° C., then heating to a temperature ranging from 1,080° C. to 1,100° C. at a heating rate of no more than 10° C./min, and then keeping at this temperature for 0.5 h to 1.0 h.

8. The method for preparing the non-oriented silicon steel for a high-speed motor according to claim 4, wherein the hot rolling includes 6 passes of rough rolling and 7 passes of finish rolling processes; and/or,
an intermediate billet with a thickness of 30 mm to 45 mm is obtained through rough rolling, and a hot-rolled plate with a thickness of 2.0 mm to 3.0 mm is obtained through finish rolling; and/or, a final rolling temperature of finishing rolling is in a range from 800° C. to 860° C., a cooling temperature of finishing rolling is in a range from 600° C. to 660° C., a variation range of the final rolling temperature of finishing rolling and the cooling temperature of finishing rolling is ±15° C., and the total reduction rate of finishing rolling is in a range from 92.5% to 93.5%.

9. The method for preparing the non-oriented silicon steel for a high-speed motor according to claim 4, wherein after normalizing, the normalized steel plates are cooled to a temperature ranging from 80° C. to 150° C., and then shot blasting and pickling processes are performed.

10. The method for preparing the non-oriented silicon steel for a high-speed motor according to claim 4, wherein the pickled steel plates are preheated to a temperature ranging from 100° C. to 200° C. before cold rolling; and/or, a size of the recrystallized grains after normalizing is in a range from 60 m to 80 m, and a volume ratio of the recrystallized grains is 100%.

11. The non-oriented silicon steel for a high-speed motor according to claim 1, comprising the following chemical components in mass percentage: 3.1%-3.4% of Si, and 0.002%-0.004% of Nb.

12. The non-oriented silicon steel for a high-speed motor according to claim 1, wherein the non-oriented silicon steel for a high-speed motor has a yield strength greater than or equal to 569 MPa.

13. The method for preparing the non-oriented silicon steel for a high-speed motor according to claim 4, wherein a size of the recrystallized grains after normalizing is in a range from 64 m to 76 m.

14. The method for preparing the non-oriented silicon steel for a high-speed motor according to claim 4, wherein the non-oriented silicon steel for a high-speed motor has a yield strength greater than or equal to 550 MPa, a magnetic induction B₅₀₀₀ greater than or equal to 1.65, a high-frequency iron loss at a thickness of 0.30 mm P_{1.0/1000} less than or equal to 45 W/kg, a high-frequency iron loss at a thickness of 0.25 mm P_{1.0/1000} less than or equal to 40 W/kg, and a high-frequency iron loss at a thickness of 0.20 mm P_{1.0/1000} less than or equal to 35 W/kg.

15. The method for preparing the non-oriented silicon steel for a high-speed motor according to claim 4, wherein, the content of (Si+2Al) is greater than or equal to 4.8 wt % and less than or equal to 5.2 wt %.

16. The method for preparing the non-oriented silicon steel for a high-speed motor according to claim 5, wherein a vacuum induction furnace is used for smelting, the content of (C+S+N) is controlled to be greater than 0 and less than or equal to 0.0050 wt %, and a continuous casting billet with a thickness of 200 mm to 250 mm is casted.

17. The method for preparing the non-oriented silicon steel for a high-speed motor according to claim 5, wherein the step of cooling and heating on the continuous casting billet comprises naturally cooling the continuous casting billet to a temperature ranging from 400° C. to 500° C., then heating to a temperature ranging from 1,080° C. to 1,100° C. at a heating rate of no more than 10° C./min, and then keeping at this temperature for 0.5 h to 1.0 h.

18. The method for preparing the non-oriented silicon steel for a high-speed motor according to claim 5, wherein the hot rolling includes 6 passes of rough rolling and 7 passes of finish rolling processes; and/or,
an intermediate billet with a thickness of 30 mm to 45 mm is obtained through rough rolling, and a hot-rolled plate with a thickness of 2.0 mm to 3.0 mm is obtained through finish rolling; and/or, a final rolling temperature of finishing rolling is in a range from 800° C. to 860° C., a cooling temperature of finishing rolling is in a range from 600° C. to 660° C., a variation range of the final rolling temperature of finishing rolling and the cooling temperature of finishing rolling is ±15° C., and the total reduction rate of finishing rolling is in a range from 92.5% to 93.5%.

19. The method for preparing the non-oriented silicon steel for a high-speed motor according to claim 5, wherein after normalizing, the normalized steel plates are cooled to a temperature ranging from 80° C. to 150° C., and then shot blasting and pickling processes are performed.

20. The method for preparing the non-oriented silicon steel for a high-speed motor according to claim 5, wherein the pickled steel plates are preheated to a temperature ranging from 100° C. to 200° C. before cold rolling; and/or, a size of the recrystallized grains after normalizing is in a range from 60 m to 80 m, and a volume ratio of the recrystallized grains is 100%.
